(19) United States
(12) Patent Application Publication
(10) Pub. No.: US 2011/0080258 A1
(43) Pub. Date: Apr. 7, 2011

(54) Identity

(76) Inventor: Kim R. Curtis, Chicago, IL (US)

(21) Appl. No.: 12/803,880

(22) Filed: Jul. 8, 2010

Related U.S. Application Data
(60) Provisional application No. 61/270,759, filed on Jul. 13, 2009.

(51) Int. Cl. G06F 7/04; G10L 21/00

(52) U.S. Cl. 340/5.72; 704/270; 704/E15.001

(57) ABSTRACT

The present invention is a new type of luxury automobile which would implement numerous ergonomically designed innovations which would deter various criminal activities which would include car theft, carjacking, and driving under the influence. Identity is a security mechanism installed on car doors that requires a fingerprint scan prior to the keypad being revealed.

If the fingerprint scan is not recognized the keypad is not revealed and access to the vehicle is denied.

Identity would be installed during the manufacturing of the vehicle or can be utilized by existing vehicles.

Fingerprint scans would be programmed by the individual or individuals who will be authorized to entry.

More than one fingerprint scan could be programmed into identity. Anyone authorized to drive the vehicle could have their fingerprint scanned. Identity only recognizes the authorized, programmed fingerprint scans.

When identity recognizes a previously programmed fingerprint scan, the cover over the keypad opens and reveals the keypad with numbers. The number combination to open unlock the door is issued by the manufacturer.

Newer model vehicles equipped with identity would no longer have to have exterior door handles or key entries.

Identity can also be programmed as a security feature for other consumer products.

To present the Identity, as invented by Kim Curtis. Conceptually speaking, this invention is a new type of luxury automobile which would implement numerous ergonomically designed features and safety and protective innovations would deter various criminal activities. Which would include car theft, carjacking and driving while drinking. Full details will be presented in the following text.

### BRIEF DESCRIPTION

Markup

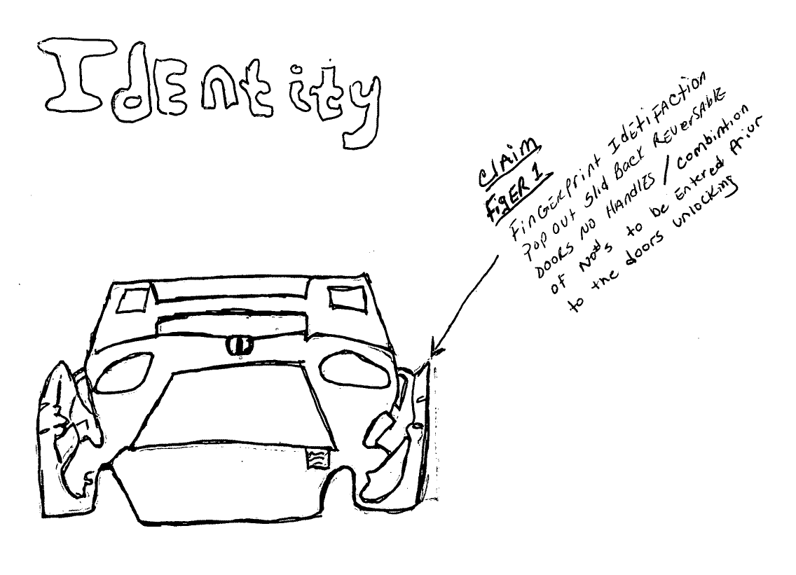

FIG. 1. Security Mechanism installed on car doors that requires fingerprint identification scan prior to the keypad being revealed. Code may be changed from home computer or cellular phone.

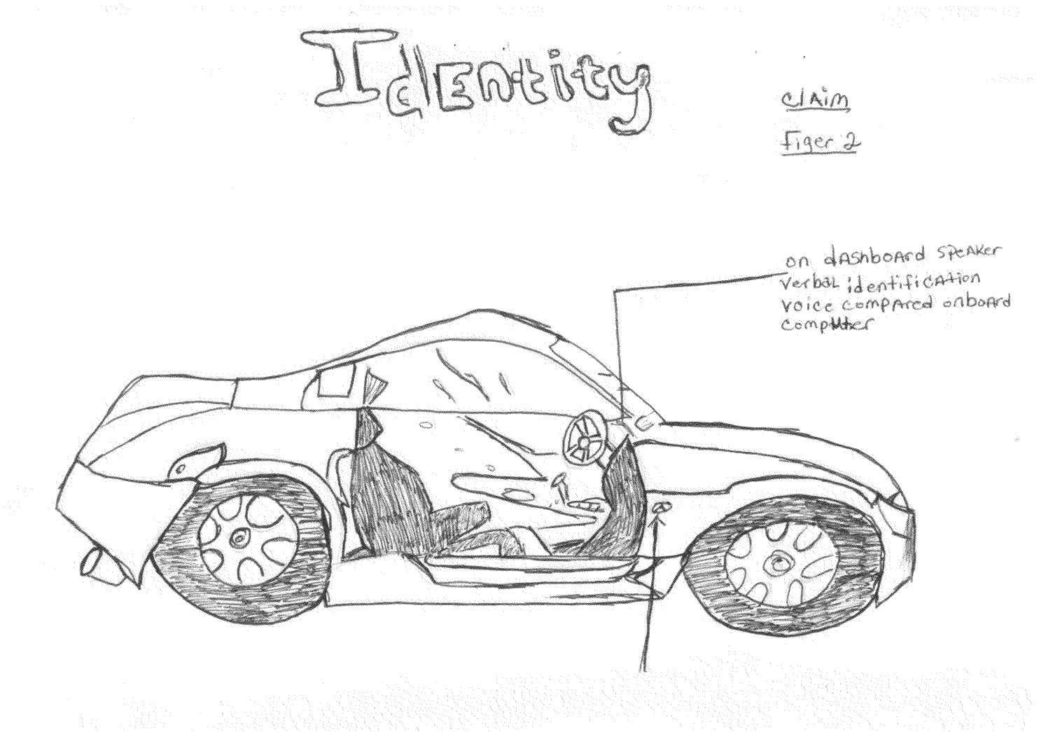

FIG. 2.—Voice recognition Sensor mechanism is on the dash board.

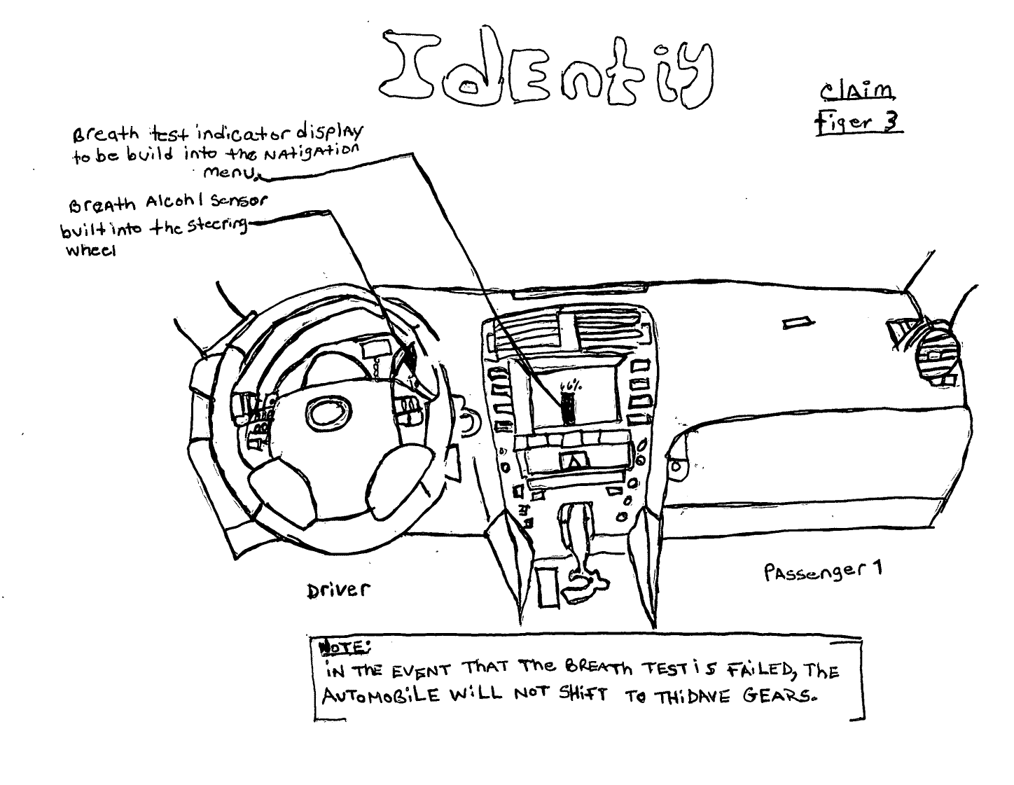

FIG. 3.—Alcohol sensor built into the steering wheel.

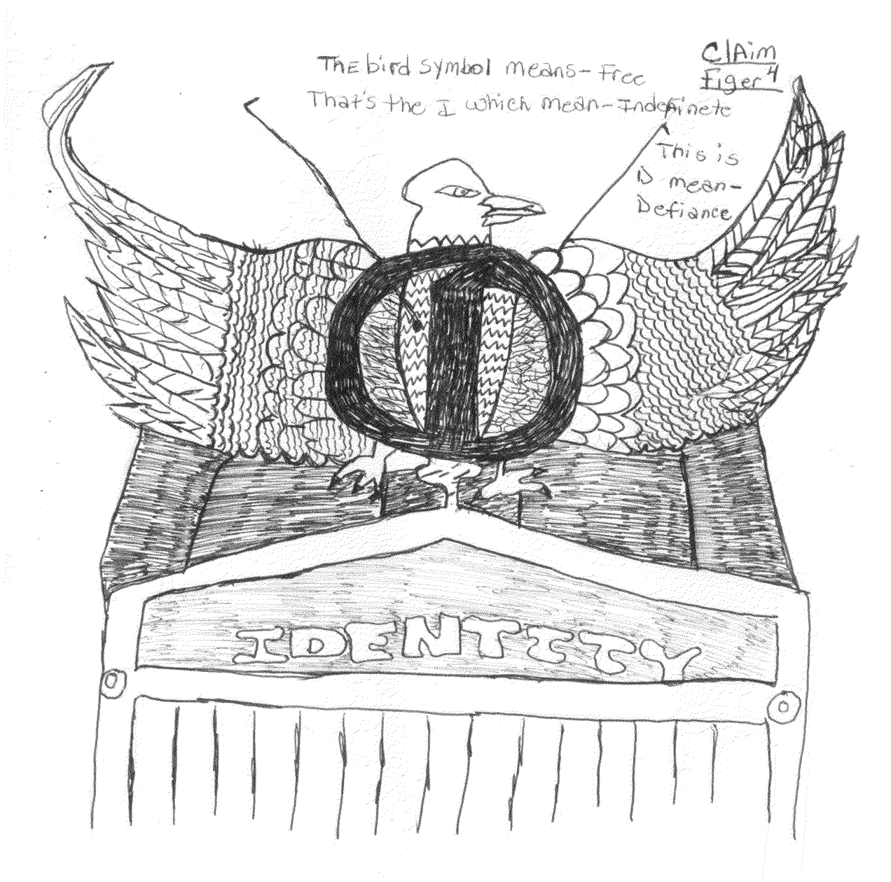

FIG. 4.—Built in Alarm system would activate in the event that the vehicle is stolen. Menu is included to increase the options of recovering the vehicle as quickly as possible.

### PRODUCT SPECIFICATIONS

No matter what kind of car an individual drives, a majority of motorist feels that car safety features are not effective in preventing personal safety problems. According to a recently conducted survey over half {52 percent} are more concerned about personal safety when driving than they were a year ago. Their top three serious safety concerns are carjacking {52.6 percent}, intentional bumping to rob or steal the car {28.1 percent} and phony/staged accidents {11.3 percent}. Motorist, particularly women are also increasingly concerned about safety walking to and from their cars at the local mall and when driving through crime-ridden neighborhoods. A study from Americas research group indicates that women's primary safety concerns when shopping include driving through a neighborhood with a high reported crime rate {75.7 percent}, walking back to the car with hands full of packages [49.4 percent} and unlocking the car {43.2 percent}. The subject of this report, the identity, is a new type of luxury car which implements a number of innovative safety features designed to combat these types of personal safety problems. Additionally, a number of economically designed features are also incorporated to improve the comfort and convenience afforded to motorist. The Identity was conceived by Kim R. Curtis. The standard model of the identity will be a five passenger model equipped with a six cylinder engine with electronic ignition and clean burn combustion chamber design. The design feature is noteworthy as this type, the engine would require nothing more than a routine maintenance for 100,000 miles. The engine would operate on regular unleaded fuel. Instruments and controls are well laid out and easy to see and the stereo system would be positioned to enable the driver to change stations or unit being played {radio, cd or tv}. Look up stock market, checking the weather, to download work from office or home. Internet capabilities would be included. By Voice command would eliminate the need to press a button on the stereo control panel. Eliminating the need to lean forward towards the dash board. The identity is utilized and electronically controlled, four speed automatic transmission that accelerates well and shifts smoothly. The identity will be equipped with an array of sensors that monitor engine speed, vehicle speed, throttle position, and rate of change, engine torque and even altitude. These data, in turn, are used to tailor shift timing and intensity to suit the driving situation. Ignition timing is momentarily retarded during shifts to smooth gear engagement. An overdrive top gear ratio and torque converter contribute to quiet highway cruising and fuel efficiency. Safety features include standard dual air bags and anti-lock braking system (ABS). Personal safety features include a locking mechanism on the doors which would require fingerprint identification or a combination of numbers to be entered prior to the doors unlocking. The combinations numbers required to open the door could be changed by use of remote control unit which is supplied with the vehicle. After unlocking, the doors would automatically slide open, a necessary feature as no handles are provided on the exterior side of the door.

After entering the vehicle, the motorist must speak into a speaker on the dashboard and issue a verbal identification which would be voice compared by the onboard computer to verify the motorist is authorized to drive the vehicle. Should voice recognition not be achieved, the vehicle cannot be started. These will be very effective features which would greatly reduce the possibility of carjacking. {002} Another personal safety feature {003}. Is an alcohol sensor which would sample the interior of the air after the individual sits in the driver seat. Should the alcohol level be too high, the identity could not start for three hours. If this situation arises, the onboard computer would issue an audible query to determine if the driver wishes to call a friend. Should the driver respond that a friend should be called, a programmed number would be automatically called and the driver could converse with another individual, requesting their assistance to drive the car home? The onboard computer also automatically issues a greeting whenever a driver or passenger sits in the seat and informs the driver and/or passengers of the time of date.

In the event the vehicle was stolen, despite these safeguards, a built in alarm system would be activated and a signal transmitted which would be received by a small receiver attached to an electronic key ring that would be supplied with the vehicle. This would alert the owner of the vehicle that the identity had been stolen. The owner would contact the police and/or other cognizant authorities. Another personal feature is a GPS satellite receiver which would supply geographic positional information defining the location of the vehicle. A red button, position on a electronic key ring would be depressed which would transmit the location of the vehicle and the name of the owner via cellular telephone frequencies to 911 emergency number. This would alert authorities of the need for emergency assistance, a feature that would be most beneficial for high risk individuals who are prone to experiencing a heart attack or other life threatening conditions.

All of the safety features incorporated into the identity would make this a very safe car to drive, with occupants being well protected against incurring injuries from accidents or becoming the victim of a criminal act by other individuals. The provision made to prevent alcohol impaired individuals from driving and the personal location system for high risk individuals augment the overall safety afforded this vehicle. All of the safety features, combined with the ergonomic features, would make the identity a very popular vehicle with the motoring public, a huge and viable market arena.

### Production Plan

This section of the marketability report discusses the various aspect of producing the identity. It also explains the standard industrial classification system (SIC), assigns appropriate sic codes to the invention, and reviews the state of the industry that would most likely make the invention into a finished product.

1. Locking mechanism on door requiring fingerprint identification/chamber of numbers. Door automatically slides open necessary feature as no handles are provided on exterior.

2. on verbal identification steering wheel fingerprinting/cam. Built in menu system GPS locator voice command menu system.

3. Alcohol sensor that detects interior air once the driver is seated.
